(19) United States
(12) Patent Application Publication
(10) Pub. No.: US 2018/0149244 A1
(43) Pub. Date: May 31, 2018

(54) STRUCTURAL UNIT INCLUDING AT LEAST ONE HOUSING PART AND AT LEAST ONE SENSOR, AND METHOD

(71) Applicant: Aktiebolaget SKF, Goteborg (SE)

(72) Inventors: Hans Peter Panzer, Loerrach (DE); Dominik Gerber, Muttenz (CH); Marcel Soltermann, Sankt Pantaleon (CH); Martin Voegelin, Diegten (CH)

(21) Appl. No.: 15/826,036

(22) Filed: Nov. 29, 2017

(30) Foreign Application Priority Data
Nov. 30, 2016 (DE) 102016223733.0

(51) Int. Cl. F16H 25/20; G01D 5/14

(52) U.S. Cl. CPC F16H 25/2015; F16H 2025/2031; G01D 5/145

(57) ABSTRACT

A structural unit includes at least one housing part configured to be mounted on an exterior surface of a linear actuator and at least one sensor displaceably supported relative to the housing part. The linear actuator may include a case having a longitudinal axis and a longitudinal slot and a ball nut mounted in an interior of the case for translational movement inside the case. The housing may be mounted on an external surface of the case over the longitudinal slot, and a threaded element may extend from a first end of the housing to a second end of the housing. The sensor may be supported by the threaded element such that rotating the threaded element moves the sensor along the threaded element, and the sensor may be configured to sense a position of the ball nut.

### CROSS-REFERENCE

This application claims priority to German patent application no. 10 2016 223 733.0 filed on Nov. 30, 2016, the contents of which are fully incorporated herein by reference.

### TECHNOLOGICAL FIELD

The disclosure is directed to a structural unit that comprises a housing and a sensor.

### BACKGROUND

Structural units are known that include at least one housing part and at least one sensor.

### SUMMARY

An aspect of the disclosure comprises achieving a high efficiency.

The disclosure is directed to a construction unit including at least one housing part and at least one sensor.

According to the disclosure, the sensor is displaceably supported relative to the housing part. Accordingly a high efficiency can be achieved. In particular, various positions of the sensor relative to the housing part can be set in a simple manner.

Furthermore a method is disclosed for switching off a drive of a thrust tube of a linear actuator, wherein the thrust tube or a component that is attached to the thrust tube actuates a switch by moving relative to an outer tube of the linear actuator, wherein the switch is displaceable relative to the outer tube. According to the disclosure a high efficiency can be achieved.

A further aspect of the disclosure comprises a linear actuator that includes a case having a longitudinal axis and a longitudinal slot extending in a direction and a ball nut mounted in an interior of the case for translational movement inside the case. A housing is mounted on an external surface of the case over the longitudinal slot such that an interior of the case communicates with an interior of the housing, and a threaded element extends in the direction from a first end of the housing to a second end of the housing. A sensor is mounted on the threaded element such that rotating the threaded element moves the sensor along the threaded element. The sensor is configured to sense a position of the ball nut.

Further advantages arise from the following description of the drawings. Exemplary embodiments of the invention are depicted in the drawings. The drawings, the description, and the claims contain numerous features in combination. The person skilled in the art will also advantageously consider the features individually and combine them into further meaningful combinations.

### BRIEF DESCRIPTION OF THE DRAWINGS

FIG. 1 is a perspective view, partly in section, of part of a linear actuator that includes a structural unit having a sensor according to an embodiment of the disclosure.

FIG. 2 is a different sectional perspective view of the part of the linear actuator illustrated in FIG. 1.

FIG. 3 is a perspective view, partly in section, of part of a linear actuator that includes a structural unit having an alternative sensor according to an embodiment of the disclosure.

FIG. 4 is a different sectional perspective view of the part of the linear actuator illustrated in FIG. 3.

### DETAILED DESCRIPTION

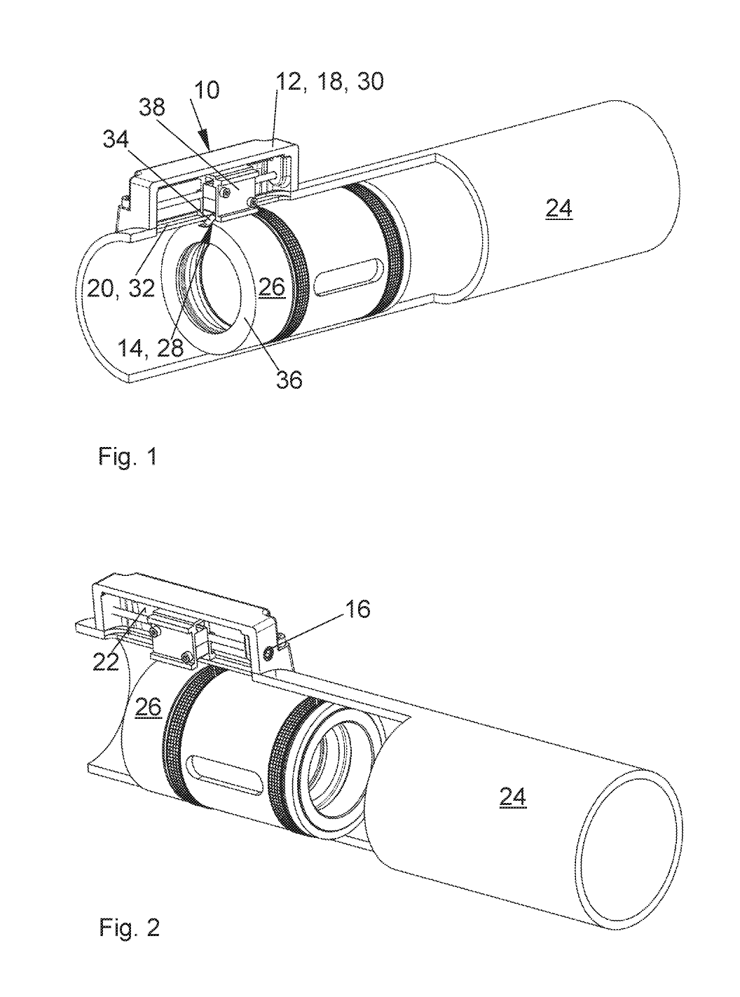

FIG. 1 shows a partial section through a part of a linear actuator including an inventive structural unit 10, which is fixedly screwed onto an outer tube 24 of the linear actuator. The structural unit includes a housing part 12 and a switch 28 that is a sensor 14. The housing part 12 has approximately a shape of a pot pulled apart in one of its width directions and therefore comprises an opening 32 on a side 20, which is facing the outer tube and which opposes a base 30 of the housing part 12. In an unassembled state of the structural unit an inside 22 of the housing part 12 is accessible via the side 20.

The sensor is supported relative to the housing part 12 such that it is displaceable by, for example, 50 mm. For this purpose the structural unit comprises an adjustment device 16 that is configured as a screw. The screw penetrates the housing part 12, and specifically such that it is rotatable from an outside 18 of the housing part 12. Both ends of the screw 16 are rotatably supported on the housing part 12. The switch 28 is attached to a carrier 38 of the structural unit. The screw is screwed into a nut attached to the carrier. When the screw rotates, the center of mass of the switch 28 moves translationally relative to a center of mass of the screw, whereby torque, which is transmitted from the screw to the switch 28, is in turn transmitted from the switch 28 to the housing part 12. The switch 28 can thus be moved along a longitudinal direction of the outer tube 24 by rotating the screw.

The switch 28 is a microswitch and includes an actuation element 34 including a curved region that projects into an interior of the outer tube when a component 26 of the linear actuator, which component 26 is configured as a ball nut, to which a thrust tube (not shown) is attached, is not disposed in one of its two end positions. The ball nut is movable back and forth translationally relative to the outer tube and between the two end positions by a drive of the linear actuator that drives a threaded spindle (not shown) that is screwed-in into the ball nut. Using the structural unit it is ensured that the ball nut is not moved further by the drive when it reaches a first of the two end positions. When the ball nut reaches the first end position, an end of the ball nut that is disposed between an end side 36 and a radial outer surface of the ball nut steers the actuation element radially outward, whereby the switch 28 and thus the sensor is mechanically actuated and it sends an electrical signal to the drive through a cable, which is guided by the housing part 12, so that it stops its movement.

The structural unit is fixedly screwed to the outer tube and thus is part of the outer tube in an assembled state. During assembly of the structural unit, the opening 32 is disposed directly on an equally large opening of the outer tube, and the housing part 12 is fixedly screwed to the outer tube.

The structural unit is retrofittable in an existing linear actuator. For this purpose an opening is introduced into the outer tube of the respective linear actuator, which opening corresponds to the size of the opening 32. Thereafter the structural unit is mounted to the outer tube as described above.

One advantage of the structural unit is that due to its functional principle it is mountable at various positions along the longitudinal direction of the outer tube and it is thereby freely choosable, for example, with a retrofitting, at which point the first end position of the ball nut should be. One advantage of a retrofitting is that the structural unit is completely preinstallable. Furthermore, the structural unit can be mounted on the widest variety of outer tubes, in particular on those that are made of steel or aluminum. In particular, the structural unit can also be installed on round or square or angular outer tubes.

Using the structural unit a good protection can be achieved of the functionally relevant parts against moisture and dust. The structural unit corresponds to protection class IP66 (IEC Ingress Protection Code 66, meaning that the enclosure is dust proof and resistant to the entry of water in the form of heavy seas or powerful jets).

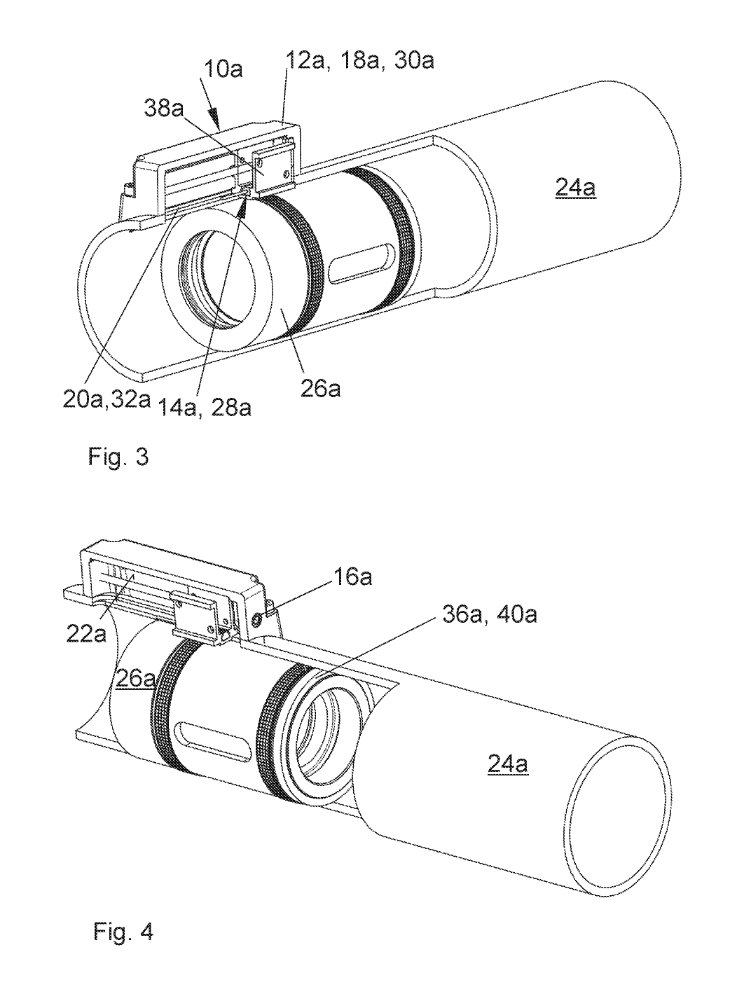

An alternative exemplary embodiment is depicted in FIGS. 3 and 4. Components, features, and functions remaining essentially identical are generally numbered with the same reference numbers. However, to differentiate the exemplary embodiments the letter “a” is added to the reference numbers of the exemplary embodiments in FIG. 4. The following description is essentially limited to the differences to the exemplary embodiment in FIG. 1 and FIG. 2, wherein with respect to components, features, and functions remaining the same, reference can be made to the description of the exemplary embodiment in FIG. 1 and FIG. 2.

A sensor 14a of the component of the alternative exemplary embodiment of FIGS. 3 and 4 senses magnetic fields. On an end side 36a of a ball nut 26a a ring is disposed that is configured as a permanent magnet. The ring is part of the ball nut. When the ball nut moves in the vicinity of the sensor, the sensor senses a magnetic field generated by the ring and triggers a switching operation, which effects that a drive of the linear actuator, whose part is the structural unit, is deactivated.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved structural units and sensors.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

10 Structural unit
12 Housing part
14 Sensor
16 Adjustment means
18 Outer side
20 Side
22 Inner side
24 Outer tube
26 Component
28 Switch
30 Base
32 Opening
34 Actuation element
36 End side
38 Carrier
40 Ring

What is claimed is:

1. A structural unit comprising:
at least one housing part configured to be mounted on an exterior surface of a linear actuator; and
at least one sensor displaceably supported relative to the housing part.

2. The structural unit according to claim 1, wherein the sensor is a mechanical sensor or a magnetic sensor.

3. The structural unit according to claim 2, further including means for adjusting a position of the sensor relative to the housing part.

4. The structural unit according to claim 3, wherein the means for adjusting comprises a screw.

5. The structural unit according to claim 1, including the linear actuator, wherein the at least one sensor is configured to sense a position of a component of the linear actuator.

6. The structural unit according to claim 5, wherein the structural unit is retrofittable on the linear actuator for realizing an end-position switching for a thrust tube.

7. A linear actuator including the structural unit of claim 1.

8. The linear actuator according to claim 7, further including:
a case having a longitudinal axis and a longitudinal slot extending in a direction; and
a ball nut mounted in an interior of the case for translational movement inside the case;
wherein the housing is mounted on an external surface of the case over the longitudinal slot such that an interior of the case communicates with an interior of the housing;
wherein a threaded element extends in the direction from a first end of the housing to a second end of the housing;
wherein the sensor is supported by the threaded element such that rotating the threaded element moves the sensor along the threaded element, and
wherein the sensor is configured to sense a position of the ball nut.

9. The linear actuator according to claim 8, wherein the sensor is configured to produce an output signal when the sensor senses the presence of the ball nut.

10. A linear actuator comprising:
a case having a longitudinal axis and a longitudinal slot extending in a direction;
a ball nut mounted in an interior of the case for translational movement inside the case;
a housing mounted on an external surface of the case over the longitudinal slot such that an interior of the case communicates with an interior of the housing;
a threaded element extending in the direction from a first end of the housing to a second end of the housing; and
a sensor mounted on the threaded element such that rotating the threaded element moves the sensor along the threaded element,
wherein the sensor is configured to sense a position of the ball nut.

11. A method for switching off a drive of a thrust tube of the linear actuator of claim 9, wherein the thrust tube or a component that is attached to the thrust tube actuates the sensor by a movement relative to the case.
